(19) United States
(12) Patent Application Publication
(10) Pub. No.: US 2019/0279232 A1
(43) Pub. Date: Sep. 12, 2019

(54) JOB ROLE IDENTIFICATION

(71) Applicant: INTERNATIONAL BUSINESS MACHINES CORPORATION, Armonk, NY (US)

(72) Inventors: Chang Yu Miao, Shanghai (CN); Dong Sheng Li, Shanghai (CN); Jun Chi Yan, Shanghai (CN); Min Gong, Shanghai (CN); Stephen Mingyu Chu, Beabercreek, OH (US)

(21) Appl. No.: 15/916,892

(22) Filed: Mar. 9, 2018

(51) Int. Cl. G06Q 30/02; G06F 17/30; G06F 17/21

(52) U.S. Cl. CPC G06Q 30/0201; G06F 17/21; G06F 17/30705; G06Q 30/0282

(57) ABSTRACT

Method, computer program products, system are provided for job role identification. The computer implemented method comprises that receiving product purchase data of a plurality of organizations which comprise buyer information and product information and generating based on the buyer information and the product information, a plurality of buyer clusters. Further, at least one job role for at least one generated buyer cluster is determined.

### BACKGROUND

The present application relates to improved data processing, and more specifically, to method, system and computer program product for job role identification from enterprise sales data.

Recommendation systems are becoming increasingly popular in recent years and are utilized in a variety of different areas especially in products distribution. An ecommerce platform typically owns a large amount of sales data from which more targeted recommendations are determined and presented to its users.

### BRIEF SUMMARY

Additional aspects and/or advantages will be set forth in part in the description which follows and, in part, will be apparent from the description, or may be learned by practice of the invention.

In one illustrative embodiment of the present invention, there is provided a computer implemented method in which product purchase data of a plurality of organizations which comprise buyer information and product information are received and based on the buyer information and the product information, a plurality of buyer clusters is generated. Further, at least one job role for at least one generated buyer cluster is determined.

In yet another illustrative embodiment of the present invention, there is further provided a computer program product which comprising a computer readable storage having a computer readable program stored therein, wherein the computer readable program, when executed on a computing device, causes the computing device to receive product purchase data of a plurality of organizations which comprise buyer information and product information, generate a plurality of buyer clusters based on the buyer information and the product information, and determine at least one job role for at least one generated buyer cluster.

In still another illustrative embodiment of the present invention, there is provided a system comprising a processor, a memory coupled to the processor, wherein the memory comprises instructions which, when executed by the processor, cause the processor to receive product purchase data of a plurality of organizations which comprise buyer information and product information, generate a plurality of buyer clusters based on the buyer information and the product information, and determine at least one job role for at least one generated buyer cluster.

These and other features and advantages of the present invention will be described in, or will become apparent to those of ordinary skill in the art in view of, the following detailed description of the example embodiments of the present invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 depicts a cloud computing node according to an embodiment of the present invention;

FIG. 2 depicts a cloud computing environment according to an embodiment of the present invention;

FIG. 3 depicts abstraction model layers according to an embodiment of the present invention;

FIG. 4 illustrates a flowchart of an exemplary method 400 according to an embodiment of the present invention;

FIG. 5 illustrates exemplary buyer information 501 and product information 502 comprised in the enterprise sales data according to an embodiment of the present invention; and

FIG. 6 illustrates exemplary identified job roles 600 according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

In products distribution, ecommerce platforms play a very important role in modern business world. With the utilization of recommendations systems, how to provide better recommendations becomes extremely important. However, recommendations provided by an ecommerce platform sometimes are not quite accurate or even poor for those who work for large organizations as traditional recommendation methods utilized by the ecommerce platform only consider its historical sales data in a coarse-grained manner. Embodiments of the invention are targeting the problems mentioned above and provide more fine-grained recommendations.

Embodiments of the invention can be deployed on cloud computer systems which will be described in the following. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

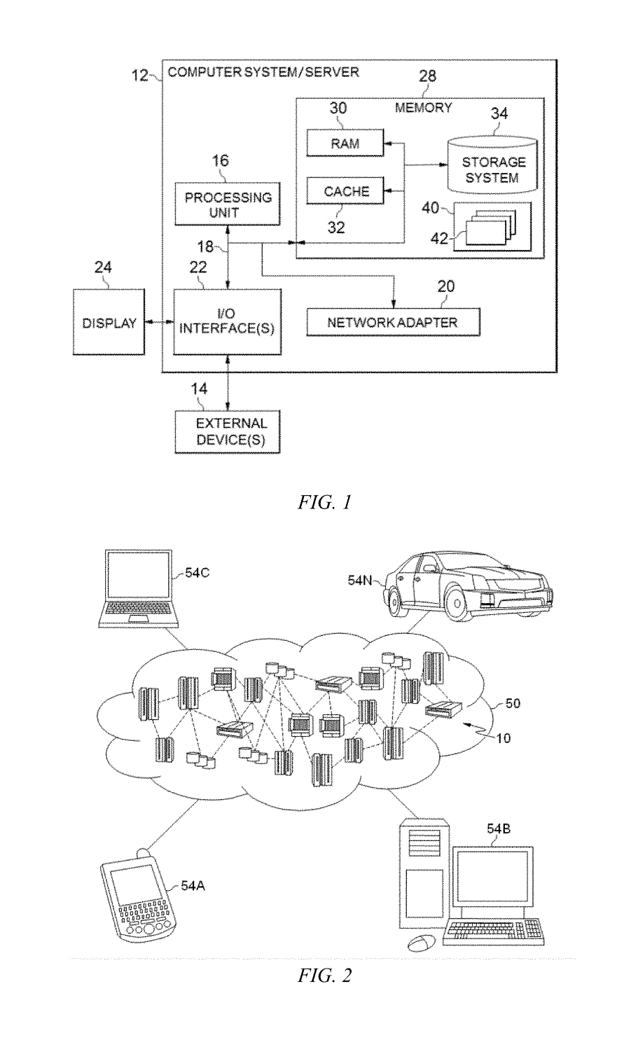

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

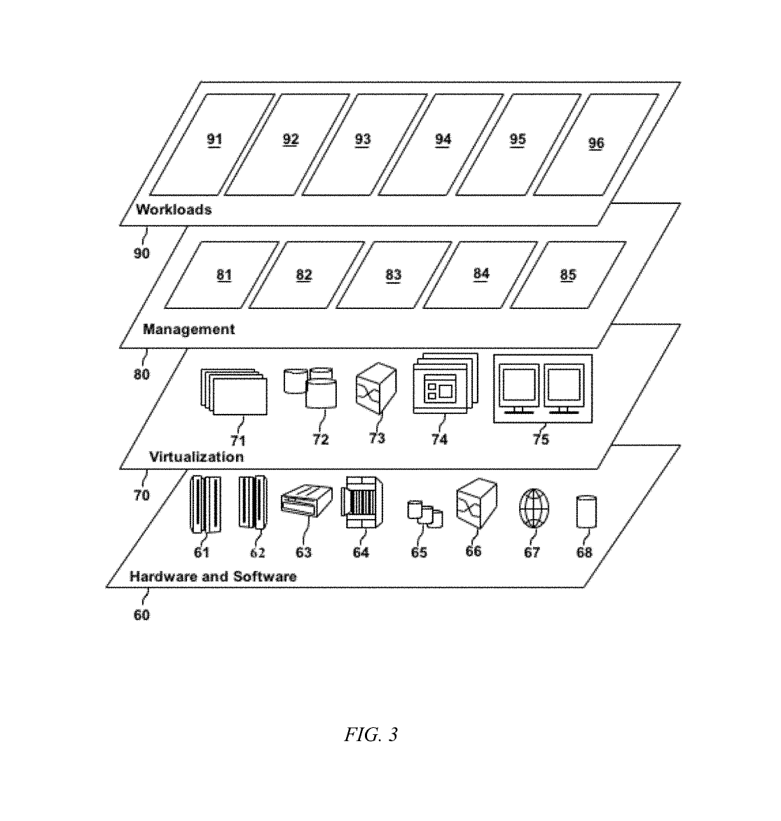

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and recommendation processing 96 according to embodiments of the invention.

As aforementioned, for those who work for large organizations, traditional recommendation systems of ecommerce platforms sometimes fail to provide accurate recommendations due to the way the recommendation systems utilize the historical sales data. A recommendation system provides a buyer with recommendations based on at least one of the following criteria: 1) purchase history of the buyer; 2) purchase history of other buyers who purchased the same products of the buyer; 3) purchase history of other buyers who purchased similar products of the buyer.

From the above, it can be seen clearly that recommendations provided by some recommendation systems are focused on products. Buyers will be considered as related even they are of totally different backgrounds so long as they purchased same or similar products. This coarse-grained recommendation sometimes does not work so well for large organizations due to the complexity of the organizational structures as different organizations may have quite different structures, as well as the lack of fine-grained analysis of the historical sales data.

Embodiments of the present invention try to solve the problems mentioned above and provide more fine-grained recommendations by introducing the concept of ‘job title’ and ‘job role’ to traditional recommendations systems.

A ‘job title’ is a term that describes in a few words or less the position held by an employee. It usually is the name of the position with the organization hierarchy. Depending on the job, a job title can describe the level of the position or the responsibilities of the person holding the position, or sometimes, both. A ‘job role’ is a description of what a person does. It usually is the part that is played within a specific process within the organization. So, a job title speaks to certain abilities and typical tasks based on training and experience, but also speaks to the level of the job within the organization, while a job role is the application of talents and abilities specific to a situation. A person holding a job title can have different job roles in different situations. In most cases, an employee in a large organization is assigned with at least one job title, but not a job role. And, different organizations usually use different job title systems. In a nutshell, it is easy to retrieve a person's job title, not the job roles. However, to a recommendation system of an ecommerce platform, job roles of a buyer is a more proper and more efficient way to describe a his/her purchase preference, not the job title.

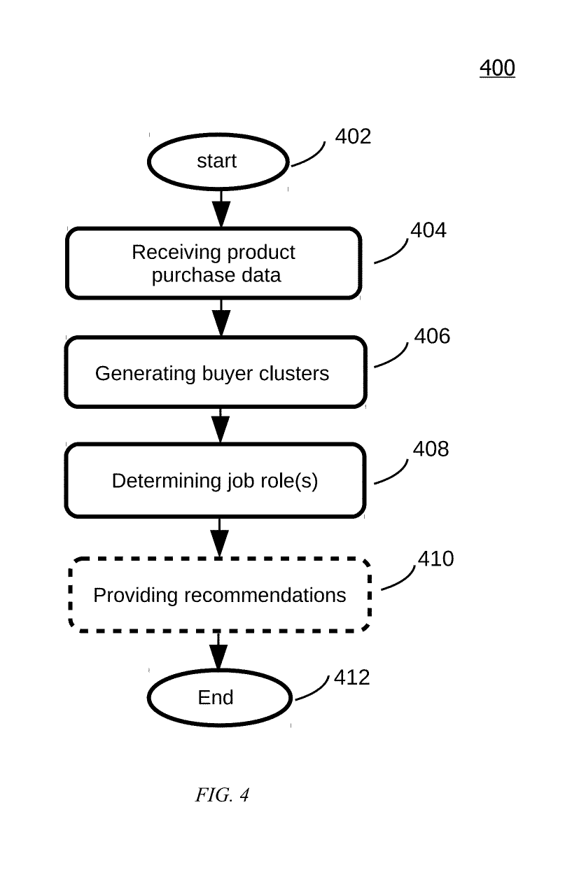

According to an embodiment of the present invention, in order to provide more accurate recommendations, there is provided a method to identify job roles from historical sales data of an ecommerce platform. In the following, the embodiment will be described by referring to the FIG. 4 which depicts a flowchart of an exemplary method 400 according to an embodiment of the present invention. The method 400 could be deployed in one or more ecommerce platforms to identify, based on the historical sales data it owns, job role(s) of a buyer. It is clear to a person skilled in the art that the method could be easily replicated to other kind of systems as long as the system owns, or can obtain historical sales data for analysis purpose. The invention will be described with the example of ecommerce platforms for the purpose of simplified illustration, but not to adversely limit the scope of the invention.

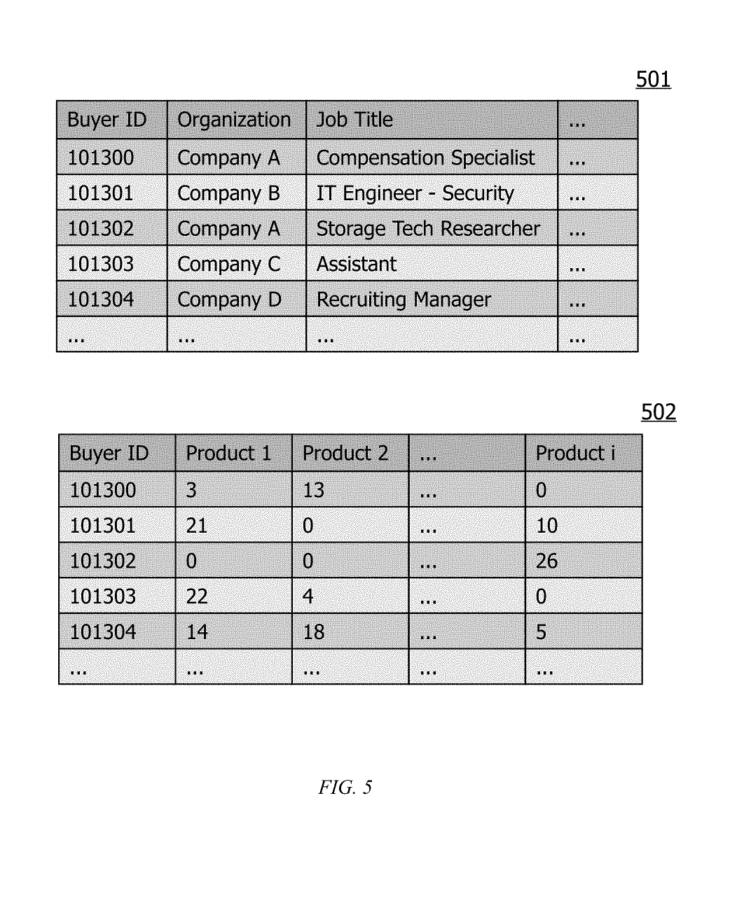

Referring to FIG. 4, the method 400 according to an embodiment of the present invention starts at Step 402 followed by Step 404, in which product purchase data of a plurality of organizations are retrieved. As described above, the product purchase data could be retrieved from an ecommerce platform or any other possible data sources. In the following, the invention will be described with the data source being an ecommerce platform for the purpose of simplified illustration, however, it should be understood that it will not adversely limit the scope of the invention. According to an embodiment of the present invention, the product purchase data retrieved from the ecommerce platform comprise buyer information and product information. Here, buyer information is the data that describe a buyer's personal information including his/her ID, the organization he/she belongs to, his/her job title, or the like. Product information is the data that describe products information that a buyer purchased via the ecommerce platform. FIG. 5 depicts exemplary buyer information 501 and product information 502 comprised in the enterprise sales data retrieved from an ecommerce platform according to an embodiment of the present invention in which: for buyer information 501: Buyer ID is the identifier of a buyer; Organization is the organization the buyer belongs to; Job Title is the job title of the buyer in the organization; for product information 502: Buyer ID is the identifier of a buyer; Product 1 to Product i are the product purchase data of the buyer.

It should be noted that the exemplary buyer information 501 and product information 502 are only to give an idea of what kind of data structure the above-mentioned information can take, and what kind of information the above-mentioned information can comprise, however, not limited to the examples. A person skilled in the art could adopt any possible data structure with any possible information based on the needs.

In Step 406, a plurality of buyer clusters are generated based on the buyer information and the product information comprised in the purchase data. According to an embodiment of the invention, a plurality of product clusters are generated by clustering, for example, same or similar products purchased by different buyers. After clustering based on the product information, a plurality of product clusters are generated. Then, a buyer cluster for a product cluster is further generated by retrieving job titles of the buyers of the product(s) in the product cluster from the buyer information.

Now, with reference to the examples of buyer information 501 and product information 502 of FIG. 5, product clusters (PC1, PC2, . . . PCi) (i.e., for same products) could be generated respectively for Product 1, Product 2, . . . and Product i. When there are similarities among products (for example Product 1 and Product i are similar products), a product cluster for the similar products could be further generated for Product 1 and Product i by further clustering them into one cluster (PC(1,i)). Then, job titles of the buyers of the same product(s) in the respective product cluster are retrieved from the buyer information to generate respective buyer clusters (BC1, BC2, . . . BCi). When there are similarities among products (for example Product 1 and Product i are similar products), a buyer cluster for the buyers of the similar products could be further generated for cluster (PC(1,i)) to generate corresponding buyer cluster (BC(1,i)). After clustering, such buyer clusters could be generated shown by Table 1 below. The last two entries in Table 1 below illustrate a cluster between similar products.

TABLE 1

BC1 = {Compensation Specialist, IT Engineer -
Security, Assistant, Recruiting Manager}
BC2 = {Compensation Specialist, Assistant,
Recruiting Manager}
. . .
and
BCi = {Compensation Specialist, Storage Tech
Researcher, Assistant}
BC(1,i) = {Compensation Specialist, IT Engineer -
Security, Storage Tech Researcher, Assistant, Recruiting
Manager}
BC2 = {Compensation Specialist, Assistant,
Recruiting Manager}

It should be noted that although above description utilizes very simple examples, a person skilled in the art that has the knowledge will know that this is only for the purpose of simplified illustration. Also, a person skilled in the art that has the knowledge will know that the clustering process is an algorithm based process. For example, the clustering of products and buyers may utilize any existing algorithm nowadays or future developed for example K-means clustering, GMM (Gaussian Mixture Models) clustering, etc.

It should also be noted that only job titles are retrieved to generate buyer clusters in above description, organization information, as well as any other related information could also be retrieved together to generate buy clusters. Again, above description utilizes very simple examples, a person skilled in the art that has the knowledge will know that this is only for the purpose of simplified illustration.

After buyer clusters are generated, at least one job role is determined for a buyer cluster in Step 408. According to an embodiment of the present invention, for a buyer cluster: keywords are extracted from the retrieved job titles; the extracted keywords are sorted based on their respective occurring frequencies; at least one job role is determined based on the sorted keywords.

In the above, keywords extraction and sorting can utilize any existing algorisms nowadays or future developed. After the extracted keywords are sorted according to their respective occurring frequencies, top ranked keywords in a decreased manner will be selected and based on which job roles are determined. For example, top ranked keywords list of the sorted keywords for buyer cluster BC2 mentioned above in Table 1, is as shown BC2={Compensation Specialist, Assistant, Recruiting Manager}, a job role ‘Human Resource’ could be determined for the buyer cluster BC2 utilizing a text categorization process. Job role determination from extracted keywords is substantially a text categorization process, which can utilize any algorithms existing nowadays or developed in the future, and could be implemented with machine learning by one or more neural networks, or with reference to a knowledge base. Text categorization, also known as text classification, is technology nowadays in natural language processing (NLP), therefore it will not be discussed in detail in the present disclosure. However, it should be understood by a person skilled in the art that any existing or future developed algorithms for text classification could be utilized by the invention to determine job roles based on the sorted keywords.

Further, to increase the productivity and speed of the job role determination process, according to another embodiment of the present invention, prior to the sorting of the extracted keywords, one or more pre-processing is performed on the extracted keywords including but not limited to: translating extracted keywords to a single language, which is to make sure all keywords are represented in the same language for easy processing; normalizing letters in the extracted keywords, which is to normalize keywords into a simple form for easy processing; stemming the extracted keywords, which is to get the stems of keywords to omit variations, etc. However, it should be understood by a person skilled in the art that the pre-processing is not limited to those mentioned above, any other pre-processing may be performed without departing from the spirit of the invention.

After job roles are successfully determined in Step 408, optionally, the method 400 can further comprise Step 410, which provides recommendations based on the determined job roles and the product purchase data. The method 400 can either provide product recommendations to the at least one job role determined, or alternatively, provide job role recommendations to the at least one product. Now it can be seen clearly that recommendation systems developed with embodiments of the present invention could provide fine-grained recommendations, i.e., a ‘job role’ based recommendation either provide product recommendations to a certain job role, or job role recommendations to a certain product. This is because embodiments of the present invention further determine job roles based on the product purchase data, which means the data are used in a more fine-grained way comparing with existing approaches. Then, in Step 412, the method 400 ends.

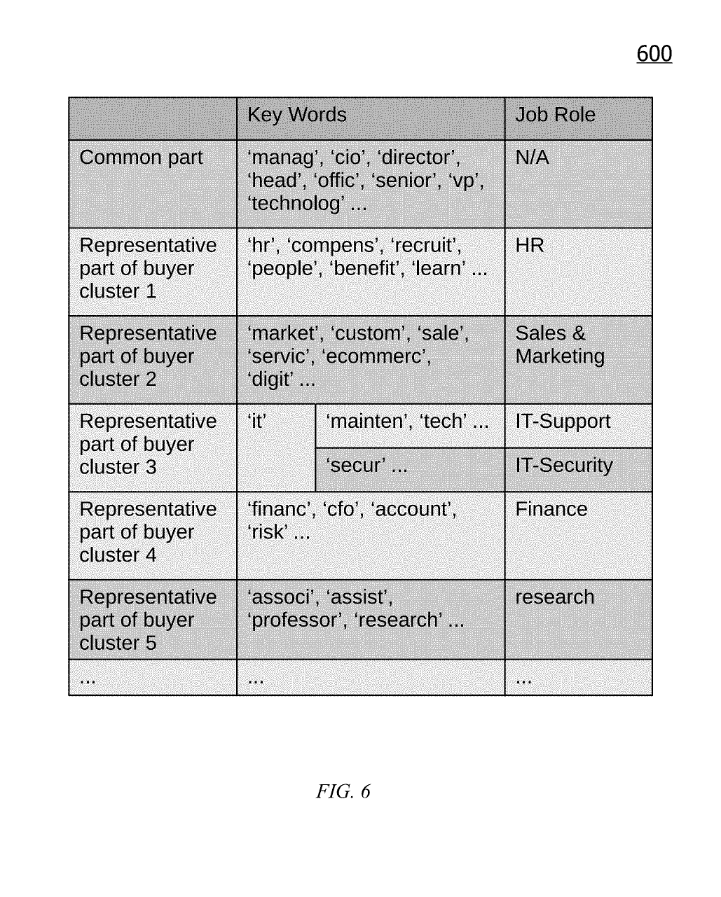

In the above, embodiments of the present invention are described with references to the figures. FIG. 6 further illustrates exemplary identified job roles 600 according to an embodiment of the present invention. Here it should be pointed out that the example is not the same example as what was discussed in FIG. 5, but rather a final determined job roles for each of the buy clusters together with sorted keywords. It can be seen clearly in the table 600 that aside from the keywords for each of the clusters, one or more corresponding job roles is determined. For the first row in the table 600, as it is common part (e.g., manager, director, etc.) of the job titles which typically is related to management function, thus no job role was determined, shown as ‘N/A’. It should be understood by a person skilled in the art that table 600 shown in FIG. 6 is only for illustration purpose, identified job roles can take any possible data structures existing or future developed, so long as it can serve the recommendation system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Based on the foregoing, a computer system, method, and computer program product have been disclosed. However, numerous modifications and substitutions can be made without deviating from the scope of the present invention. Therefore, the present invention has been disclosed by way of example and not limitation.

While the invention has been shown and described with reference to certain exemplary embodiments thereof, it will be understood by those skilled in the art that various changes in form and details may be made therein without departing from the spirit and scope of the present invention as defined by the appended claims and their equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the one or more embodiment, the practical application or technical improvement over technologies found in the marketplace, or to enable others of ordinary skill in the art to understand the embodiments disclosed herein.

What is claimed is:

1. A computer implemented method, comprising:
receiving a product purchase data of a plurality of organizations, wherein the product purchase data comprises buyer information and product information;
generating a plurality of buyer clusters by clustering the purchase data based on the buyer information and the product information; and
determining at least one job role for at least one buyer cluster of the plurality of buyer clusters of at least one buyer,
wherein the receiving, generating and determining are carried out by one or more processing units.

2. The method of claim 1, wherein the generating a plurality of buyer clusters comprising:
generating a plurality of product clusters based on the product information;
for at least one product cluster,
retrieving, from the buyer information, job titles of the buyers of products in the cluster;
generating a buyer cluster by clustering the retrieved job titles.

3. The method of claim 2, wherein the determining at least one job role comprising:
for at least one buyer cluster,
extracting keywords from the retrieved job titles;
sorting the extracted keywords based on their respective frequencies;
determining at least one job role based on the sorted keywords.

4. The method of claim 3, further comprising:
prior to the sorting, pre-processing the extracted keywords.

5. The method of claim 4, wherein the pre-processing comprising at least one of the following:
translating the extracted keywords to a single language;
normalizing letters in the extracted keywords; and
stemming the extracting keywords.

6. The method of claim 1, further comprising:
providing, to the at least one determined job role, product recommendations based on the determined job roles and the product purchase data.

7. he method of claim 1, further comprising:
providing, to at least one product, job role recommendations based on the determined job roles and the product purchase data.

8. A computer program product comprising a computer readable storage medium having a computer readable program stored therein, wherein the computer readable program, when executed on a computing device, causes the computing device to:
receive product purchase data of a plurality of organizations, wherein the product purchase data comprising buyer information and product information;
generate a plurality of buyer clusters by clustering based on the buyer information and the product information; and
for at least one buyer cluster, determine at least one job role.

9. The computer program product of claim 8, wherein the computer readable program further causes the computing device to:
generate a plurality of product clusters based on the product information;
for at least one product cluster,
retrieve, from the buyer information, job titles of the buyers of products in the cluster;
generate a buyer cluster by clustering the retrieved job titles.

10. The computer program product of claim 9, wherein the computer readable program further causes the computing device to:
for at least one buyer cluster,
extract keywords from the retrieved job titles;
sort the extracted keywords based on their respective frequencies;
determine at least one job role based on the sorted keywords.

11. The computer program product of claim 10, wherein the computer readable program further causes the computing device to:
pre-process the extracted keywords prior to the sorting.

12. The computer program product of claim 11, wherein the pre-processing comprising at least one of the following:
translating the extracted keywords to a single language;
normalizing letters in the extracted keywords; and
stemming the extracting keywords.

13. The computer program product of claim 8, wherein the computer readable program further causes the computing device to:
provide, to the at least one determined job role, product recommendations based on the determined job roles and the product purchase data.

14. The computer program product of claim 8, wherein the computer readable program further causes the computing device to:
provide, to at least one product, job role recommendations based on the determined job roles and the product purchase data.

15. A system, comprising:
a processor; and
a memory coupled to the processor, wherein the memory comprises instructions which, when executed by the processor, cause the processor to:
receive product purchase data of a plurality of organizations, wherein the product purchase data comprising buyer information and product information;
generate a plurality of buyer clusters by clustering based on the buyer information and the product information; and
for at least one buyer cluster, determine at least one job role.

16. The system of claim 15, wherein the instructions further cause the processor to:
generate a plurality of product clusters based on the product information;
for at least one product cluster,
retrieve, from the buyer information, job titles of the buyers of products in the cluster;
generate a buyer cluster by clustering the retrieved job titles.

17. The system of claim 16, wherein the instructions further cause the processor to:
for at least one buyer cluster,
extract keywords from the retrieved job titles;
sort the extracted keywords based on their respective frequencies;
determine at least one job role based on the sorted keywords.

18. The system of claim 17, wherein the instructions further cause the processor to:
pre-process the extracted keywords prior to the sorting.

19. The system of claim 15, wherein the instructions further cause the processor to:
provide, to the at least one determined job role, product recommendations based on the determined job roles and the product purchase data.

20. The system of claim 15, wherein the instructions further cause the processor to:
provide, to at least one product, job role recommendations based on the determined job roles and the product purchase data.
